(19) United States
(12) Patent Application Publication
(10) Pub. No.: US 2019/0256080 A1
(43) Pub. Date: Aug. 22, 2019

(54) Method for the Situation-Based Adaptation of the Charging Strategy of Energy Stores of a Vehicle

(71) Applicant: Bayerische Motoren Werke Aktiengesellschaft, Muenchen (DE)

(72) Inventors: Dominik KERLER, Bad Laer (DE); Moritz SCHINDLER, Muenchen (DE); Maximilian VON LOEWENFELD, Markt Schwaben (DE)

(21) Appl. No.: 16/404,428

(22) Filed: May 6, 2019

Related U.S. Application Data
(63) Continuation of application No. PCT/EP2017/076225, filed on Oct. 13, 2017.

(30) Foreign Application Priority Data
Nov. 7, 2016 (DE) 10 2016 221 786.0

(51) Int. Cl. B60W 20/16; B60W 10/06; B60W 10/26; B60W 30/18

(52) U.S. Cl. CPC B60W 20/16; B60W 10/06; B60W 10/26; B60W 2710/06; B60W 2510/244; B60W 2510/06; B60W 30/18018

(57) ABSTRACT

A method for a situation-based adaptation of a charging strategy of energy stores of a vehicle having automatic start-stop functionality includes identifying whether a current stop-and-go situation is present based on prescribed criteria during a current driving situation of the vehicle, and performing, in response to the current stop-and-go situation being present, an intensified charging of an energy store of the vehicle during engine running between two automatically initiated engine-off phases.

### CROSS REFERENCE TO RELATED APPLICATIONS

This application is a continuation of PCT International Application No. PCT/EP2017/076225, filed Oct. 13, 2017, which claims priority under 35 U.S.C. § 119 from German Patent Application No. 10 2016 221 786.0, filed Nov. 7, 2016, the entire disclosures of which are herein expressly incorporated by reference.

### BACKGROUND AND SUMMARY OF THE INVENTION

The invention relates to a method for the situation-based adaptation of the charging strategy of energy stores of a vehicle.

The on-board power supply system and the supply of power thereto is now a key aspect in vehicle development. Micro hybrid vehicles have already been produced for some time and have the advantage that they have an automatic start-stop system, that is to say an electronic system that turns off the engine when the vehicle has been braked to a standstill and when the driver holds down the brake pedal (in a vehicle with an automatic gearbox) and that turns the engine on again when the driver takes their foot off the brake, and recuperation function, that is to say brake energy recovery, in order to charge the starter battery. This technology can save fuel. Micro hybrid vehicles cannot use their energy stores for electric driving.

The charging and discharging of the starter battery or generally of energy stores in the vehicle depends almost exclusively on current (actual) characteristic variables of the on-board energy supply system, for example on the state of charge of the energy store or stores, consumer current, generator load level or also the temperature.

Systems commonly referred to as queue assistants have already been produced particularly in (fully) hybrid vehicles, which adapt the state of charge of the battery during travel in an anticipatory manner in order, for example, upon reaching a queue, which is identified in advance by appropriate systems, on the route to be traveled, to be able to drive purely electrically in the queue or stop-and-go traffic resulting therefrom. However, this requires systems that operate predictively, that is to say receive data from the outside in order to be able to implement this operating strategy.

However, in the case of frequent automatically initiated engine stops, the operating strategy described above may also result in the state of charge of the energy store being identified as too low to switch off the engine, with the result that the engine is not automatically switched off. Before this situation occurs, it may be that the automatic start-stop system is operated inefficiently on account of the poorer state of charge of the energy store, that is to say, for example, the engine is started in a more uncomfortable manner, which manifests itself as jerking, for example. That is to say that the availability of the automatic start-stop system in known systems in situations with frequent automatically initiated engine stops reduces. Although the availability also depends on the configuration of the vehicle, that is to say how many consumers still have to be operated in the case of an automatically initiated engine-off situation, the state of charge of the battery and hence the availability reduces even in the case of a low number of consumers or consumers that require only little energy.

One possibility of increasing the availability is to turn off certain consumers in the automatically initiated engine-off state. However, this is not desired for reasons of comfort, among other things. To further improve said problem, newer systems have a dual store system, DSS for short, in order to ensure a higher availability of the supply of energy to the on-board power supply system even in the case of start-stop functionality. However, these systems are not adapted or are adapted only partly to the current driving situation, that is to say they operate as before with predictive logic.

For this reason, it is an object of the present invention to provide a method and an apparatus, which solves the mentioned problems. In particular, a situation-based adaptation of the charging strategy of the energy store or stores provided in the vehicle is intended to be carried out.

The invention proposes a method for the situation-based adaptation of the charging strategy of energy stores of a vehicle having automatic start-stop functionality, comprising at least one energy store with high charge absorption capability, wherein, in a first step, an identification as to whether a current stop-and-go situation is present is carried out on the basis of prescribed criteria during the current driving situation of the vehicle, and, in a second step, if a current stop-and-go situation has been identified, intensified charging of the energy store is carried out during engine running between two automatically initiated engine-off phases.

Provision is furthermore made for prescribed criteria to include that, within a predetermined period, a defined number of automatically initiated engine stops has been detected, and/or a cumulative duration of automatically initiated engine stops has been detected, and/or a cumulative discharge quantity from the first and/or the second energy store during detected automatically initiated engine stops has been detected. The predetermined period is preferably within a range of from 1 minute to 8 minutes, preferably is 5 minutes. The cumulative discharge quantity is preferably within a range of from 1 ampere hour (Ah) to 5 ampere hours (Ah), preferably 2 ampere hours (Ah).

Provision is furthermore made for, in the second step, the current state of charge of the at least one energy store to also be detected, and for the intensified charging of the energy store to be carried out during engine running between two automatically initiated engine-off phases depending on the detected state of charge.

Provision is furthermore made for the energy store to be one or more lithium-ion battery (batteries), one or more double-layer capacitors, one or more flywheel stores. Provision is furthermore made for the vehicle to be a micro hybrid vehicle. Provision is furthermore made for, in the second step, the intensified charging of the energy store to be carried out during engine running between two automatically initiated engine-off phases by the internal combustion engine.

Provision is furthermore made for the intensified charging between two automatically initiated engine-off phases to be carried out in such a way that the charge quantity of the energy store is increased in such a way that the availability of automatically initiated engine stops is increased. That is to say that the state of charge of the energy store is increased at least to a prescribed value. The prescribed value can in this case be several ampere hours. Owing to the intensified charging, on the one hand, a state of charge that makes automatically initiated engine stops possible is reached quickly. On the other hand, a higher state of charge increases the availability of the automatic start-stop system, that is to say more and/or longer stops are possible. This can be achieved by virtue of charging that is intensified in comparison to previous strategies between two (possible) automatically initiated engine stops taking place, that is to say that a higher current is used for charging than without an identified stop-and-go situation. However, this can also be achieved by virtue of charging to a higher state of charge taking place. That is to say that intensified charging after an automatically initiated engine-off phase makes it possible to turn off the engine in the next standstill phase. The intensified charging can take place both depending on the detected state of charge of the energy store and at each automatically initiated engine stop.

Provision is furthermore made for a control apparatus, comprising at least one control unit, wherein the control apparatus is arranged in a vehicle and is configured to detect a current stop-and-go situation, and to perform the disclosed method or to transmit signals for performing the disclosed method to a performance apparatus.

Provision is furthermore made for the control unit to be further configured to detect the current state of charge of at least one energy store arranged in the vehicle with a high charge absorption capability.

Provision is furthermore made for a computer program product to process the described method.

Further features and advantages of the invention result from the following description of exemplary embodiments of the invention, with reference to the figures of the drawing, which shows inventive details, and from the claims. The individual features can each be realized separately or together in any desired combination in a variant of the invention.

Preferred embodiments of the invention are explained in more detail below with reference to the appended drawing.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of essential components according to one embodiment of the present invention.

FIG. 2 shows a flow chart of the method according to one embodiment of the present invention.

In the following descriptions of the figures, identical elements or functions are provided with identical reference signs.

### DETAILED DESCRIPTION OF THE DRAWINGS

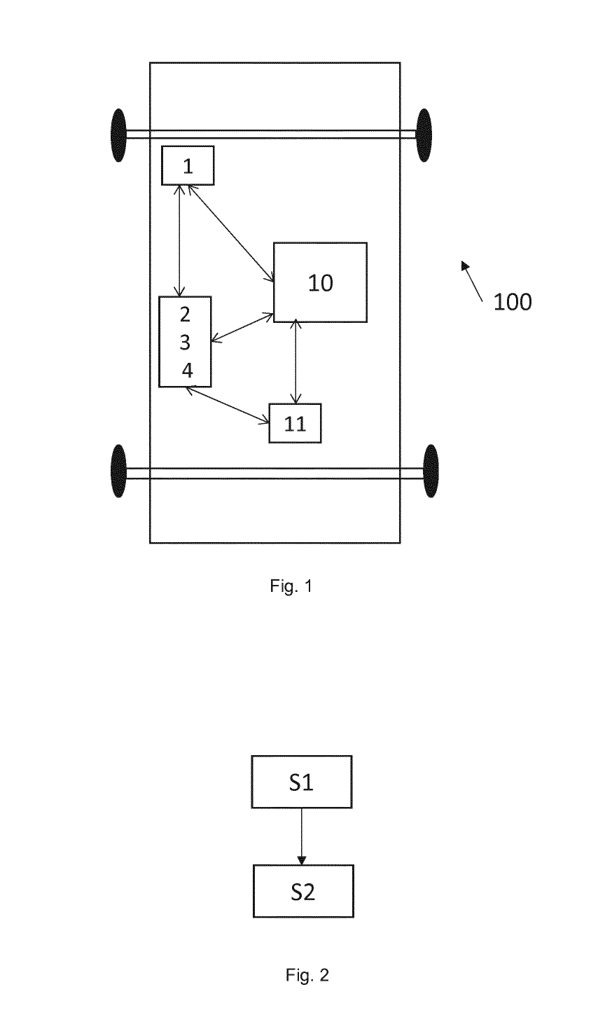

FIG. 1 shows a schematic illustration of essential components according to one embodiment of the present invention. The modern on-board power supply system of a vehicle 100 essentially consists of a generator, one or more energy stores 1, 11, wherein one thereof is generally a lead-acid battery and the other is a battery with a high power absorption capability, such as a lithium-ion battery, and various energy consumers 2, 3, 4. The energy consumers 2, 3, 4 have developed further from the beginning when only the start, ignition and illumination systems were operated. Nowadays, a multiplicity of consumers 2, 3, 4 constituting for the most part control, comfort and safety functions are installed in the vehicle 100. This multiplicity of energy consumers 2, 3, 4 increases the power demand placed on the energy supply system or the energy store 1, 11. The lead-acid battery 1 is now referred to as an on-board power supply system battery, since it has to sustain increasingly more power requirements from systems that the generator can no longer operate. For example, the battery in vehicles with a start-stop system (also referred to as MSA) has to take on the sole power supply of the on-board power supply system. The use and the state of the battery are determined and monitored, for example, by the energy management system 10, which can be provided, for example, as a control apparatus, for example as an engine control unit with an integrated start-stop coordinator and a sensor for monitoring the state of charge of the energy store or stores.

Energy consumers 2, 3, 4 can be divided into groups, for example into basic consumers 2, which are required for the operation of the vehicle, for example the engine control unit, convenience consumers 3, for example the navigation system, the air-conditioning system, driver assistance systems etc., and driving-dynamics consumers 4, for example the anti-lock braking system, the electronic stability program, etc.

To reduce consumption in vehicles 100, even in micro hybrid vehicles, two functionalities, among others, are essential: the recuperation and the automatic engine start-stop function. In the case of recuperation, the generator power is increased and the excess energy in the energy store 1, 11 is stored in deceleration phases. Therefore, the energy store can output the stored energy and the generator can be operated at a lower power in phases with an increased energy demand. In the case of automatically initiated engine stops, the (internal combustion) engine is turned off in standstill phases of the vehicle 100. The electrical consumers 2, 3, 4 have to be supplied with power via the battery 1, 11. As soon as it is identified that the travel is to be continued, the engine is turned on again and the consumed energy is recovered completely or partly (depending on the driving mode) by means of recuperation.

The energy management system 10 monitors the state of the battery 1, 11 and intervenes when the state of charge of the battery reaches one or one of several predefined critical value(s). The intervention can be measures such as the deactivation or degradation of consumers, for example heating/air-conditioning consumers, as well as the deactivation of the automatic start-stop function.

In order to achieve a higher degree of availability, systems comprising a plurality of identical batteries or systems comprising larger lead-acid batteries have been proposed and are also in production. In addition to the conventional lead-acid battery 1, more cycle-stable batteries, for example a lithium-ion battery 11, are installed as energy stores in DSS systems, which are used, for example, in micro hybrid vehicles. Said lithium-ion battery has a significantly higher reliability and a significantly higher charge absorption capability in comparison to the lead-acid battery 1, with the result that it satisfies the requirements especially for the availability in the case of high battery loading. Therefore, a higher degree of availability is already inherently ensured. Since the performance of lithium-ion batteries is however very strongly dependent on temperature, it is necessary to further improve the previous concepts and to provide a corresponding charging concept.

FIG. 2 describes the depicted flow chart of the method according to one embodiment of the present invention. In a first step S1, an identification as to whether a stop-and-go situation is currently present is carried out on the basis of prescribed criteria during the current driving situation of the vehicle 100. Such criteria are, for example, that, within a predetermined period, a defined number of automatically initiated engine stops has been detected, and/or a cumulative duration of automatically initiated engine stops has been detected, and/or a cumulative discharge quantity from the first and/or the second energy store during detected automatically initiated engine stops has been detected. In this case, the cumulative discharge quantity is advantageously within a range of from 1 ampere hour (Ah) to 5 ampere hours (Ah) and is preferably 2 ampere hours (Ah). The specified criteria are not exhaustive. Rather, further criteria, for example, on the basis of different traffic situations, countries, etc. can be prescribed to detect a stop-and-go situation. In addition, predictively operating systems can also be included. However, the prerequisite for this is that the vehicle has such a system and the corresponding data, particularly in relation to GPS coordinates, real-time traffic information or other, also predictive, methods, even without knowledge of the location, are accurate enough.

By detecting and evaluating prescribed criteria, a stop-and-go situation can be identified without predictive systems, that is to say directly, when the situation occurs or when the aforementioned criteria occur or are satisfied within a determined period, for example within a period of 1 to 8, preferably of 5, minutes. By identifying the stop-and-go situation, it can be assumed that a higher-than-average number of stops, which are relevant to the automatic start-stop system, will take place in the next time. For this reason, in the second step S2, that is to say when a current stop-and-go situation has been detected, intensified charging of the energy store is triggered during engine running between two automatically initiated engine-off phases. The triggering can be effected by the energy management system 10. This achieves a situation in which the energy store, in a DSS system that is to say the battery with a high charge absorption capability such as, for example, a lithium-ion battery, reaches a higher state of charge within a short time, that is to say between two automatically initiated engine-off phases. Although this is achieved by way of fuel consumption when the generator, driven by the internal combustion engine, is used for charging, this increases the comfort, that is to say particularly the availability of the automatic start-stop system, and overall saves energy and reduces the emissions in comparison with not turning off the engine.

Intensified charging is to be understood here as meaning that the charge quantity of the energy store, that is to say preferably of the lithium-ion battery, is increased in such a way that the availability of automatically initiated engine stops is increased. When, for example, in a 10 Ah store 11, the state of charge is increased by 10%, 1 Ah more charge is available for automatically initiated engine stops. In the case of an assumed 20 A on-board power supply system current, said engine stops are 3 minutes. In this case, the current state of charge can be detected by means of an appropriate device, for example in the energy management system or the control unit as described above, in the vehicle by the energy store or stores arranged in the vehicle.

Furthermore, it is possible to determine that intensified charging is carried out only under certain conditions, for example depending on the detected state of charge. In this case, it is possible to define, for example, that intensified charging is carried out only when the detected state of charge is low or has fallen below a prescribed charge threshold. It is also possible to prescribe that the intensified charging is carried out for each automatically initiated engine stop.

The energy store used can not only be a lithium-ion battery but any energy store that satisfies the requirements of a prescribed cycle stability and charge absorption capability.

The method is preferably performed by a control apparatus, which may be an engine control unit, and can be embodied as a computer program product. The performance apparatus for performing the method can be the control apparatus itself or else be another control apparatus that receives the corresponding signals. In this respect, it is clear that the method can be performed independently of the number of control apparatuses in the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for a situation-based adaptation of a charging strategy of energy stores of a vehicle having automatic start-stop functionality, the vehicle comprising an energy store with high charge absorption capability, the method comprising:
identifying whether a current stop-and-go situation is present based on prescribed criteria during a current driving situation of the vehicle; and
performing, in response to the current stop-and-go situation being present, an intensified charging of the energy store during engine running between two automatically initiated engine-off phases.

2. The method as claimed in claim 1, wherein the prescribed criteria include that, within a predetermined period,
a defined number of automatically initiated engine stops has been detected,
a cumulative duration of automatically initiated engine stops has been detected, and/or
a cumulative discharge quantity from the energy store during detected automatically initiated engine stops has been detected.

3. The method as claimed in claim 2, wherein at least one of:
the predetermined period is between 1 minute and 8 minutes, and/or
the cumulative discharge quantity is within a range of from 1 Ah to 5 Ah.

4. The method as claimed in claim 1, further comprising detecting a current state of charge of the energy store, and wherein said performing the intensified charging of the energy store is carried out during engine running between two automatically initiated engine-off phases depending on the detected state of charge.

5. The method as claimed in claim 2, further comprising detecting a current state of charge of the energy store, and wherein said performing the intensified charging of the energy store is carried out during engine running between two automatically initiated engine-off phases depending on the detected state of charge.

6. The method as claimed in claim 1, wherein the energy store comprises a lithium-ion battery, a double-layer capacitor, a flywheel store, and/or wherein the vehicle is a micro hybrid vehicle.

7. The method as claimed in claim 1, wherein performing the intensified charging of the energy store comprises performing the intensified charging of the energy store during engine running between two automatically initiated engine-off phases by the internal combustion engine.

8. The method as claimed in claim 2, wherein performing the intensified charging of the energy store comprises performing the intensified charging of the energy store during engine running between two automatically initiated engine-off phases by the internal combustion engine.

9. The method as claimed in claim 4, wherein performing the intensified charging of the energy store comprises performing the intensified charging of the energy store during engine running between two automatically initiated engine-off phases by the internal combustion engine.

10. The method as claimed in claim 1, wherein said performing the intensified charging between two automatically initiated engine-off phases increases the charge quantity of the energy store such that an availability of automatically initiated engine stops is increased.

11. The method as claimed in claim 2, wherein said performing the intensified charging between two automatically initiated engine-off phases increases the charge quantity of the energy store such that an availability of automatically initiated engine stops is increased.

12. The method as claimed in claim 4, wherein said performing the intensified charging between two automatically initiated engine-off phases increases the charge quantity of the energy store such that an availability of automatically initiated engine stops is increased.

13. The method as claimed in claim 7, wherein said performing the intensified charging between two automatically initiated engine-off phases increases the charge quantity of the energy store such that an availability of automatically initiated engine stops is increased.

14. A control apparatus, comprising at least one control unit, wherein the control apparatus is arranged in a vehicle having an energy store with high charge absorption capability, wherein the control apparatus is configured to:
identify whether a current stop-and-go situation is present based on prescribed criteria during a current driving situation of the vehicle; and
perform, in response to the current stop-and-go situation being present, an intensified charging of the energy store during engine running between two automatically initiated engine-off phases.

15. The control apparatus as claimed in claim 14, wherein the control unit is further configured to detect the current state of charge of the energy store arranged in the vehicle with a high charge absorption capability.

16. A computer program product, including a computer readable medium having stored thereon executable program code that, when executed by one or more processors, causes the one or more processors to:
identify whether a current stop-and-go situation is present based on prescribed criteria during a current driving situation of a vehicle; and
perform, in response to the current stop-and-go situation being present, an intensified charging of an energy store during engine running between two automatically initiated engine-off phases, wherein the energy store has high charge absorption capability.
